(19) United States
(12) Patent Application Publication
(10) Pub. No.: US 2013/0299070 A1
(43) Pub. Date: Nov. 14, 2013

(54) METHODS FOR PRODUCING POLARIZING LAMINATE FILM AND POLARIZING PLATE

(71) Applicant: Shinichi Kawamura, Niihama-shi (JP)

(72) Inventor: Shinichi Kawamura, Niihama-shi (JP)

(73) Assignee: SUMITOMO CHEMICAL COMPANY, LIMITED, Tokyo (JP)

(21) Appl. No.: 13/877,025

(22) PCT Filed: Dec. 7, 2011
(86) PCT No.: PCT/JP11/78840

§ 371 Date: Jun. 11, 2013

(30) Foreign Application Priority Data
Dec. 9, 2010 (JP) 2010-274401
Sep. 1, 2011 (JP) 2011-190813

(51) Int. Cl. G02B 5/30

(52) U.S. Cl. CPC G02B 5/30
USPC 156/191; 427/163.1

(57) ABSTRACT

The present invention provide a process for producing a polarizing laminate film comprising a base film, a primer layer and a polarizer layer in order, which comprises the following steps, in order,
a primer layer formation step of forming a primer layer by applying a primer solution to one surface of a base film,
a polyvinyl alcohol resin layer formation step of forming a polyvinyl alcohol resin layer on the primer layer to obtain a laminate film comprising, in order, the base film, the primer layer and a polyvinyl alcohol resin layer,
a stretching step of stretching the laminate film, and
a dyeing step of dyeing the polyvinyl alcohol resin layer of the laminate film with a dichroic dye to obtain a polarizer layer,
   wherein a content of an epoxy type cross-linker in the primer solution is less than 0.1% by weight.

According to the present invention, such a polarizing laminate film can be provided that blocking may not occur even in the case of temporarily winding after formation of the primer layer on the base film, that sticking to a transportation roll may not occur in the subsequent transporting step, and that the adhesion between the polyvinyl alcohol resin layer and the base film in the polarizing laminate film after production may not be lowered.

### BACKGROUND OF THE INVENTION

1. Field of the Invention

The present invention relates to processes for producing a polarizing laminate film and processes for a polarizing plate.

2. Description of Related Art

Polarizing plates are widely used as an element to generate polarization and the like for display devices such as liquid crystal displays and the like. As such polarizing plates, those in which a polarizing film composed of a polyvinyl alcohol resin(PVA) is adhered to a protective film composed of triacetylcellulose (TAC) are conventionally used. Thinner and lighter polarizing plates are needed in association with recent growing applications of liquid crystal display devices to mobile devices such as notebook type personal computers and cellular phones.

Heretofore, polarizing plates have been produced by forming a polarizing film by the execution of a dyeing treatment or a cross-linking treatment either after or while stretching only a film composed of a polyvinyl alcohol resin, and then laminating the polarizing film to a protective film or the like. However, thinning is possible only to the limit thickness of a polarizing film alone. For this reason, there has been proposed a method which is capable of reducing the combined thickness of a base film and a polarizer layer to the limit level and rendering the thickness of the polarizer layer (polarizing film) smaller than before by providing a polyvinyl alcohol resin layer to be the polarizer layer on a surface of the base film, then, dry-stretching the polyvinyl alcohol resin layer together with the base film, and performing a dyeing treatment and a cross-linking treatment to convert the polyvinyl alcohol resin layer into a polarizer layer (see, for example, JP 2000-338329-A).

However, the adhesion between the base film and the polyvinyl alcohol resin layer would not be strong enough, and there is supposed a trouble that the polyvinyl alcohol resin layer is stripped from the base film in stretching in a stretching step or in immersing into a dyeing solution in a dyeing step.

Therefore, for improving the adhesion between a base film and a polyvinyl alcohol resin layer, there is a proposal of a primer layer disposed between a base film and a polyvinyl alcohol resin layer. For example, JP 2007-272176-A describes that a primer layer is formed by applying a primer solution prepared by mixing a polyvinyl alcoholic resin and a cross-linker (epoxy resin).

Since this document describes that the preferable epoxy resin compounding amount is about 0.2 to 5.5 parts by weight with respect to 100 parts by weight water as a solvent and the preferable polyvinyl alcohol resin compounding amount is about 1 to 25 parts by weight with respect to 100 parts by weight water, the content of the epoxy resin in the primer solution shall be 0.16 to 5.16 wt %. With this composition, however, there were cases in which blocking occurred when temporarily winding after forming a primer layer (mutual pressure joining of wound films) and cases in which a primer layer stuck to guide rolls and nip rolls during film transportation after forming a primer layer, leading to a trouble during film transportation.

### SUMMARY OF THE INVENTION

In view of the above-described problems, the present invention has an object of providing a process for producing a polarizing laminate film comprising forming a primer layer between a base film and a polyvinyl alcohol resin layer (polarizer layer) wherein blocking does not occur even in the case of temporarily winding after formation of the primer layer on the base film, sticking to a transportation roll does not occur in the subsequent transporting step and the adhesion between the polyvinyl alcohol resin layer and the base film in the polarizing laminate film after production does not lower.

The present invention comprises the followings.

[1] A process for producing a polarizing laminate film comprising a base film, a primer layer and a polarizer layer in order, which comprises the following steps, in order,

a primer layer formation step of forming a primer layer by applying a primer solution to one surface of a base film,
a polyvinyl alcohol resin layer formation step of forming a polyvinyl alcohol resin layer on the primer layer to obtain a laminate film comprising, in order, the base film, the primer layer and the polyvinyl alcohol resin layer,
a stretching step of stretching the laminate film, and
a dyeing step of dyeing the polyvinyl alcohol resin layer of the laminate film with a dichroic dye to obtain a polarizer layer,
wherein a content of an epoxy type cross-linker in the primer solution is less than 0.1% by weight.

[2] The process according to [1], wherein the polyvinyl alcohol resin layer formation step is carried out after winding temporarily the base film on which the primer layer has been formed in the primer layer formation step and again taking out the base film.

[3] The process according to [1], wherein the polyvinyl alcohol resin layer formation step is carried out after transporting by a roll the base film on which the primer layer has been formed in the primer layer formation step, to a place where the polyvinyl alcohol resin layer formation step is to be carried out.

[4] The process according to [3], wherein the primer formation step, the transporting and the polyvinyl alcohol resin layer formation step are carried out successively in that order.

[5] The process according to any one of [1] to [4], wherein the base film comprises polyolefin resin.

[6] The process according to any one of [1] to [5], wherein the primer solution contains polyvinyl alcohol resin.

[7] The process according to any one of [1] to [6], wherein a solvent of the primer solution is the one having low solvency for the base film.

[8] The process according to any one of [1] to [7], wherein the stretch ratio in the stretching step is more than 5.

[9] The process according to any one of [1] to [8], wherein the thickness of the primer layer before the stretching step is from 0.05 to 1.0 μm.

[10] The process according to any one of [1] to [9], wherein the thickness of the polyvinyl alcohol resin layer before the stretching step is from 3 to 30 μm.

[11] The process according to any one of [1] to [10], wherein the thickness of the polarizer layer is 10 μm or less.

[12] A process for producing a polarizing plate comprising a polarizer layer and a protective film formed on one surface of the polarizer layer, which comprises the following steps, in order,

a protective film lamination step of laminating a protective film on a surface of the polarizing laminate film opposite from the base film, wherein the polarizing laminate film is obtained by the process according to any one of [1] to [1,1], and
a base film stripping step of stripping away the base film from the polarizing laminate film.

In the present application, by means of restraining the content of an epoxy type cross-linker added into a primer solution to be used for forming a primer layer between a base film and a polyvinyl alcohol resin layer (polarizer layer) in production of a polarizing laminate film, there can be formed a primer layer manifesting no sticking to a roll for film transportation and causing no blocking in the case of temporarily winding after formation of the primer layer on the base film, without being lowered the adhesion between the polyvinyl alcohol resin layer and the base film.

### BRIEF EXPLANATION OF DRAWINGS

FIG. 1 is a flow chart showing one embodiment of a process for producing a polarizing laminate film of the present invention.

FIG. 2 is a flow chart showing another embodiment of the process for producing a polarizing laminate film of the present invention.

FIG. 3 is a flow chart showing one embodiment of a process for producing a polarizing plate of the present invention.

FIG. 4 is a flow chart showing another embodiment of the process for producing a polarizing plate of the present invention.

### MODES FOR CARRYING OUT THE INVENTION

In the present specification, a laminate in which polyvinyl alcohol (PVA) resin layer is laminated via a primer layer on one surface of a base film is called “laminate film”. A polyvinyl alcohol resin layer (layer composed of polyvinyl alcohol resin) having a function as a polarizer is called “polarizer layer”, and a laminate having a polarizer layer on one surface of a base film is called “polarizing laminate film”. A laminate having a protective film on one surface of the polarizer layer is called “polarizing plate”. The constituent elements will be illustrated in detail below.

### (Base Film)

Resins used for the base film are, for example, thermoplastic resins which are excellent in transparency, mechanical strength, thermal stability, stretchability and the like, and suitable resins can be selected according to Tg (glass transition temperature) or Tm (melting temperature) thereof. Specific examples of the thermoplastic resins include polyolefin resins, polyester resins, cyclic polyolefin resins (norbornene resins), (meth)acrylic resins, cellulose ester resins, polycarbonate resins, polyvinyl alcohol resins, vinyl acetate resins, polyarylate resins, polystyrene resins, polyether sulfone resins, polysulfone resins, polyamide resins, polyimide resins, and their mixtures, copolymers.

Out of these, in particular, polyolefin resins are suitably used.

The polyolefin resins, such as polyethylene, polypropylene, are preferable since they are easily and stably stretched at high ratio. An ethylene-propylene copolymer obtained by copolymerizing propylene and ethylene, or other copolymers can also be used. Copolymerization is possible also with other monomers, and examples of other monomers which are copolymerizable with propylene include ethylene and α-olefins. As the α-olefin, α-olefins having 4 or more carbon atoms are preferably used, and more preferable are α-olefins having 4 to 10 carbon atoms. Specific examples of the α-olefin having 4 to 10 carbon atoms include linear monoolefins such as 1-butene, 1-pentene, 1-hexene, 1-heptene, 1-octene, 1-decene and the like; branched monoolefins such as 3-methyl-1-butene, 3-methyl-1-pentene, 4-methyl-1-pentene and the like; vinylcyclohexane and the like. The copolymer composed of propylene and other monomer copolymerizable therewith may be a random copolymer or a block copolymer. The content of constituent units derived from the other monomer in the copolymer can be measured by carrying out infrared (IR) spectral measurement according to a method described in “Polymer Analysis Handbook” (1995, published by Kinokuniya Company Ltd.), p. 616.

Out of the above-described compounds, a propylene homopolymer, a propylene-ethylene random copolymer, a propylene-1-butene random copolymer and a propylene-ethylene-1-butene random copolymer are preferably used as the propylene resin constituting the propylene resin film.

Preferably, the stereoregularity of the propylene resin constituting the propylene resin film is substantially isotactic or syndiotactic. The propylene resin film composed of the propylene resin having substantially isotactic or syndiotactic stereoregularity manifests a relatively excellent handling and shows an excellent mechanical strength under high temperature environments.

The polyester resin is a polymer having an ester linkage, and predominantly, a polycondensate of a multivalent carboxylic acid and a polyhydric alcohol. As the multivalent carboxylic acid, divalent dicarboxylic acids are mainly used, and examples thereof include isophthalic acid, terephthalic acid, dimethyl terephthalate, dimethyl naphthalenedicarboxylate and the like. As the polyhydric alcohol, divalent diols are mainly used, and such as propanediol, butanediol, neopentyl glycol, cyclohexanedimethanol are noted. Specific resins include polyethylene terephthalate, polybutylene terephthalate, polyethylene naphthalate, polybutylene naphthalate, polytrimethylene terephthalate, polytrimethylene naphthalate, polycyclohexanedimethyl terephthalate, polycyclohexanedimethyl naphthalate and the like. Blended resins thereof and copolymers thereof can also be suitably used.

As the cyclic polyolefin resin, norbornene resins are preferably used. The cyclic polyolefin resin is a generic name for resins obtained by polymerizing a cyclic olefin as a polymerization unit, and for example, resins described in JP H01-240517-A, JPH 03-14882-A, JP H03-122137-A and the like are noted. Specific examples thereof include ring-opening (co)polymers of cyclic olefins, addition polymers of cyclic olefins, copolymers composed of a cyclic olefin and an α-olefin such as ethylene, propylene and the like (typically, random copolymers), graft polymers obtained by modifying these compounds with an unsaturated carboxylic acid or a derivative thereof, and hydrides thereof, and the like. Specific examples of the cyclic olefin include norbornene monomers.

As the cyclic polyolefin resin, various products are commercially available. Specific examples thereof include Topas (registered trademark) (manufactured by Ticona), ARTON (registered trademark) (manufactured by JSR Corporation), ZEONOR (registered trademark) (manufactured by ZEON Corporation), ZEONEX (registered trademark) (manufactured by ZEON Corporation), APEL (registered trademark) (manufactured by Mitsui Chemicals, Inc.) and the like.

As the (meth)acrylic resin, any suitable (meth)acrylic resins can be adopted. Examples thereof include poly(meth)acrylates such as polymethyl methacrylate, methyl methacrylate-(meth)acrylic acid copolymer, methyl methacrylate-(meth)acrylate copolymer, methyl methacrylate-acrylate-(meth)acrylic acid copolymer, methyl (meth)acrylate-styrene copolymer (MS resin, etc.), polymers having an alicyclic hydrocarbon group (for example, methyl methacrylate-cyclohexyl methacrylate copolymer, methyl methacrylate-norbornyl (meth)acrylate copolymer etc.) and the like.

PolyC1-6 alkyl (meth)acrylates such as polymethyl (meth)acrylate and the like are preferable. As the (meth)acrylic resin, methyl methacrylate-based resins containing methyl methacrylate as the main component (50 to 100 wt %, preferably 70 to 100 wt %) are more preferably used.

The cellulose ester resin is an eater of cellulose and a fatty acid. Specific examples of the cellulose ester resin include cellulose triacetate, cellulose diacetate, cellulose tripropionate, cellulose dipropionate and the like.

Further, copolymers thereof, and those obtained by modifying a part of hydroxyl groups with other substituents and the like are also noted. Out of these, cellulose triacetate is particularly preferable. As the cellulose triacetate, a variety of products are commercially available, and these are advantageous from the standpoint of easier availability and lower cost. Examples of the commercially available products of cellulose triacetate include FUJITAC (registered trademark) TD80 (manufactured by Fujifilm Corporation), FUJITAC (registered trademark) TD80UF (manufactured by Fujifilm Corporation), FUJITAC (registered trademark) TD80UZ (manufactured by Fujifilm Corporation), FUJITAC (registered trademark) TD40UZ (manufactured by Fujifilm Corporation), KC8UX2M (manufactured by Konica Minolta Opto Products Co., Ltd.), KC4UY (manufactured by Konica Minolta Opto Products Co., Ltd.) and the like.

The polycarbonate resin is an engineering plastic made of a polymer containing monomer units connected via a carbonate group, and is a resin being high in impact resistance, heat resistance and flame retardance. Because of high transparency, the polycarbonate resins are suitably used also in optical applications. In optical applications, resins called modified polycarbonates such as those having a modified polymer skeleton for lowering photoelastic coefficient, copolymerized polycarbonates having improved wavelength dependence and the like are also commercially available, and can be suitably used. Such polycarbonate resins are commercially available widely, and examples thereof include Panlite (registered trademark) (manufactured by Teijin Chemicals Ltd.), Iupilon (registered trademark) (manufactured by Mitsubishi Engineering-Chemicals Corporation), SD POLYCA (registered trademark) (manufactured by Sumitomo Dow Limited), CALIBRE (registered trademark) (manufactured by Dow Chemical K.K.) and the like.

The base film may be a film composed of only one resin among the above-described resins, or a film composed of two or more above-described resins blended. The base film may be a single-layer film or a multi-layer film.

To the base film, any suitable additives may have been added in addition to the above-described thermoplastic resins. Examples of such additives include ultraviolet absorbers, antioxidants, lubricants, plasticizers, releasing agents, coloring inhibitors, flame retardants, nucleating agents, antistatic agents, pigments, coloring agents and the like. The content of the thermoplastic resin exemplified above in the base film is preferably 50 to 100 wt %, more preferably 50 to 99 wt %, further preferably 60 to 98 wt % and particularly preferably 70 to 97 wt %. When the content of the thermoplastic resin in the base film is less than 50 wt %, properties such as high transparency that the thermoplastic resin inherently have are not manifested sufficiently in some cases.

The thickness of the base film before stretching can be appropriately determined, and in general, it is preferably 1 to 500 μm, more preferably 1 to 300 μm, further preferably 5 to 200 μm and most preferably 5 to 150 μm from the standpoint of strength and workability such as a handling and the like.

A corona treatment, a plasma treatment, a flame treatment and the like may be performed on the base film at least of which surface a primer layer is to be formed on, for improving adhesion between a polyvinyl alcohol resin layer and the base film.

### (Primer Layer)

On the surface of the base film on which a polarizer layer is to be formed, a primer layer is formed for improving adhesion between the base film and a polyvinyl alcohol resin layer. The material constituting the primer layer is not particularly restricted providing that it is a material capable of exerting certain strong adhesion force to both the base film and the polyvinyl alcohol resin layer. For example, thermoplastic resins which are used are excellent in transparency, thermal stability, stretchability and the like. Specific examples thereof include, but not limited to, acrylic resins and polyvinyl alcoholic resins. Especially, polyvinyl alcohol resins showing excellent adhesion are preferably used.

Examples of the polyvinyl alcohol resin used as the primer layer include polyvinyl alcohol resin and derivatives thereof. The derivatives of polyvinyl alcohol resin include polyvinylformal, polyvinylacetal and the like, and additionally, those obtained by modifying polyvinyl alcohol resins with an olefin such as ethylene, propylene, an unsaturated carboxylic acid such as acrylic acid, methacrylic acid, crotonic acid, an alkyl ester of an unsaturated carboxylic acid, acrylamide and the like. Among the above-described polyvinyl alcohol resin materials, polyvinyl alcohol resin is preferably used.

In the present invention, a content of an epoxy type cross-linker in a primer solution used for forming the primer layer is less than 0.1 wt %. This makes it possible to form a primer layer causing no blocking without lowering the adhesion force between the base film and the polyvinyl alcohol resin layer.

For increasing the strength of the primer layer, a cross-linker, other than epoxy type cross-linkers, may also be added to the above-described thermoplastic resin.

The epoxy type cross-linker can be added in an amount of less than 0.1 wt % in terms of a content of a solid component in a primer solution, but no addition is preferable. As the cross-linker other than epoxy type cross-linkers, known cross-linkers whether organic ones or inorganic ones can be used. For the thermoplastic resin to be used, suitable materials may be selected accordingly. The cross-linker other than epoxy type cross-linkers that can be to use are, low molecular weight cross-linkers such as isocyanate cross-linkers, dialdehyde cross-linkers, metal chelate cross-linkers, and additionally, also high molecular weight cross-linkers such as methylolated melamine resins. In the case of use of a polyvinyl alcohol resin as the thermoplastic resin, it is particularly preferable to use methylolated melamine, dialdehyde, metal chelate cross-linker and the like as the cross-linker.

The thickness of the primer layer (before stretching step) is preferably 0.05 to 1 μm and further preferably 0.1 to 0.4 μm. When thinner than 0.05 μm, there is a general tendency of lowering in adhesion force between the base film and polyvinyl alcohol layer, and when thicker than 1 μm, a polarizing plate becomes thicker.

### (Polarizer Layer)

The polarizer layer is specifically obtained one wherein a dichroic dye is allowed to be adsorbed and oriented on a uniaxially stretched polyvinyl alcohol resin layer.

As the polyvinyl alcohol resin constituting the polyvinyl alcohol resin layer, ones obtained by saponifying polyvinyl acetate resins can be used. Examples of the polyvinyl acetate resin are, copolymers composed of vinyl acetate and another monomer copolymerizable therewith, and the like, in addition to polyvinyl acetate resin as a homopolymer of vinyl acetate. Examples of the other monomer copolymerizable with vinyl acetate include unsaturated carboxylic acids, olefins, vinyl ethers, unsaturated sulfonic acids, acrylamides having an ammonium group, and the like.

The polyvinyl alcohol resin constituting the polarizer layer (polyvinyl alcohol resin layer) is one preferably completely saponified. The range of the degree of saponification is preferably 80.0 mol % to 100.0 mol %, more preferably 90.0 mol % to 99.5 mol % and further preferably 94.0 mol % to 99.0 mol %. When the degree of saponification is less than 80.0 mol %, there is a general tendency of being lower of heat resistance and resistance to moist heat of a resulting polarizing plate after a polarizing plate is obtained. In the case of use of a polyvinyl alcohol resin having a degree of saponification of over 99.5 mol %, there is a general tendency of retarding of a dyeing speed, involving cases of not obtaining sufficient polarizing performance and requiring a longer period of time than usual for production.

The degree of saponification referred to herein is a proportion of hydroxyl groups converted from acetic groups having been contained in a polyvinyl acetate resin as a raw material of a polyvinyl alcohol resin by a saponification step, the proportion being represented by unit ratio (mol %), and is a numerical value defined by the following formula. This can be determined by a method defined in JIS K 6726 (1994).

degree of saponification (mol %)=(number of hydroxyl groups)/(number of hydroxyl groups+number of acetic groups)×100

It can be noted that, when the degree of saponification grows higher, the proportion of hydroxyl groups is higher, that is, the proportion of acetic groups disturbing crystallization becomes lower.

The polyvinyl alcohol resin to be used in the present invention may be a modified polyvinyl alcohol resin having been subjected to partial modification. Examples thereof include those obtained by modifying polyvinyl alcohol resins with an olefin such as ethylene, propylene and the like, an unsaturated carboxylic acid such as acrylic acid, methacrylic acid, crotonic acid and the like, an alkyl ester of an unsaturated carboxylic acid, acrylamide and the like. The modification proportion is preferably less than 30 mol % and more preferably less than 10 mol %. When the modification proportion is over 30 mol %, a dichroic dye is unlikely adsorbed, generally tending to causing irregularities of lowered polarizing.

While the average degree of polymerization of the polyvinyl alcohol resin is not particularly restricted, it is preferably 100 to 10000, more preferably 1500 to 8000 and further preferably 2000 to 5000. Likewise the average degree of polymerization referred to herein is a numerical value determined by a method defined by JIS K 6726 (1994).

Polyvinyl alcohol resins having such properties include for examples, PVA124 (degree of saponification: 98.0 to 99.0 mol %), PVA117 (degree of saponification: 98.0 to 99.0 mol %), PVA624 (degree of saponification: 95.0 to 96.0 mol %) and PVA617 (degree of saponification: 94.5 to 95.5 mol %) manufactured by Kuraray Co., Ltd.; AH-26 (degree of saponification: 97.0 to 98.8 mol %), AH-22 (degree of saponification: 97.5 to 98.5 mol %), NH-18 (degree of saponification: 98.0 to 99.0 mol %) and N-300 (degree of saponification: 98.0 to 99.0 mol %) manufactured by The Nippon Synthetic Chemical Industry Co., Ltd.; JC-33 (degree of saponification: 99.0 mol % or more), JM-33 (degree of saponification: 93.5 to 95.5 mmol %), JM-26 (degree of saponification: 95.5 to 97.5 mol %), JP-45 (degree of saponification: 86.5 to 89.5 mol %), JF-17 (degree of saponification: 98.0 to 99.0 mol %), JF-17L (degree of saponification: 98.0 to 99.0 mol %) and JF-20 (degree of saponification: 98.0 to 99.0 mol %) manufactured by Japan Vam Poval Co., Ltd.; and the like, and can be suitably used in the present invention.

By a film formation of such a polyvinyl alcohol resin, a polyvinyl alcoholic resin layer is formed. The method of a film formation of a polyvinyl alcohol resin is not particularly restricted, and the film formation can be performed by known methods. However, it is preferable that a solution of a polyvinyl alcohol resin is applied to a base film thereby forming a film wherein a polarizer layer having desired thickness can be obtained easily.

Such a polyvinyl alcohol resin layer and together with a base film is stretched and to be oriented, followed by adsorbing and orienting of a dichroic dye to give a polarizer layer. The stretch ratio is preferably larger than 5, further preferably larger than 5 and not larger than 17.

The thickness of a polarizer layer (thickness of polyvinyl alcohol resin layer after stretching) is 10 μm or less and preferably 7 μm or less. By setting the thickness of a polarizer layer 10 μm or less, a thin polarizing laminate film can be constituted.

Examples of the dichroic dye used for a polarizer layer include iodine, organic dyes and the like. As the organic dye, it can be to use, for example, Red BR, Red LR, Red R, Pink LB, Rubin BL, Bordeaux GS, Sky Blue LG, Lemon Yellow, Blue BR, Blue 2R, Navy RY, Green LG, Violet LB, Violet B, Black H, Black B, Black GSP, Yellow 3G, Yellow R, Orange LR, Orange 3R, Scarlet GL, Scarlet KGL, Congo Red, Brilliant Violet BK, Supra Blue G, Supra Blue GL, Supra Orange GL, Direct Sky Blue, Direct Fast Orange S, Fast Black and the like. These dichroic materials may be used singly or in combination.

### (Protective Film)

The protective film may be simply a protective film having no optical function, or alternatively may be a protective film having an optical function such as a retardation film and a luminance improve film.

The material of the protective film is not particularly restricted, and films conventionally used widely in the art such as, for example, cyclic polyolefin resin films; cellulose acetate resin films composed of such resin as triacetylcellulose and diacetylcellulose; polyester resin films composed of such resin as polyethylene terephthalate, polyethylene naphthalate, polybutylene terephthalate; polycarbonate resin films, acrylic resin films, polypropylene resin films and the like are noted.

As the cyclic polyolefin resins, suitable commercially available products, for example, Topas (registered trademark) (manufactured by Ticona Company), ARTON (registered trademark) (manufactured by JSR Corporation), ZEONOR (registered trademark) (manufactured by ZEON Corporation), ZEONEX (registered trademark) (manufactured by ZEON Corporation) and APEL (registered trademark) (manufactured by Mitsui Chemicals Inc.) can be suitably used. In film formation of such cyclic polyolefin resins to give a film, known methods such as a solvent cast method, a melt extrusion method and the like are appropriately used. Further, commercially available films that have been formed beforehand made of cyclic polyolefin resins such as Escena (registered trademark) (manufactured by Sekisui Chemical Co., Ltd.), SCA40 (manufactured by Sekisui Chemical Co., Ltd.), ZEONOR (registered trademark) film (manufactured by Optes Co., Ltd.) and the like may also be used.

The cyclic polyolefin resin film may be a uniaxially stretched film or a biaxially stretched film. Stretching can give the cyclic polyolefin resin film any retardation as desired. Stretching is usually carried out continuously while unwinding a film roll, and the stretching is conducted toward a direction of traveling with a roll, a direction perpendicular to the traveling direction, or both directions, in a heat furnace. The temperature of the heat furnace is usually from around the glass transition temperature of the cyclic polyolefin resin to the glass transition temperature +100° C. The stretch ratio is usually 1.1 to 6, preferably 1.1 to 3.5, per one direction.

Preferably, a surface treatment is carried out, such as a plasma treatment, a corona treatment, an ultraviolet irradiation treatment, a flame treatment, a saponification treatment and the like onto the surface to be stuck to a polarizing film since the cyclic polyolefin resin is in general inferior in surface activity. Out of them, plasma and corona treatments, which are relatively easily operable, are preferable.

As the cellulose acetate resin film, appropriate commercially available products, for example, FUJITAC (registered trademark) TD80 (manufactured by Fujifilm Corporation), FUJITAC (registered trademark) TD80UF (manufactured by Fujifilm Corporation), FUJITAC (registered trademark) TD80UZ (manufactured by Fujifilm Corporation), FUJITAC (registered trademark) TD40UZ (manufactured by Fujifilm Corporation), KC8UX2M (manufactured by Konica Minolta Opto Products Co., Ltd.), KC4UY (manufactured by Konica Minolta Opto Products Co., Ltd.) and the like can be suitably used.

May be formed a liquid crystal layer and the like on the surface of the cellulose acetate resin film for improving a view angle property. Cellulose acetate resin films having been stretched for imparting retardation may be available. A saponification treatment is usually performed onto the cellulose acetate resin film, for enhancing adhesiveness to a polarizing film. For the saponification treatment, immersion into an aqueous solution of an alkali such as sodium hydroxide and potassium hydroxide can be adopted.

On the surface of the protective film as described above, an optical layer such as a hard coat layer, an anti-glare layer, an anti-reflection layer and the like can be formed. The method of forming these optical layers on the surface of the protective film is not particularly restricted, and known methods can be used.

The protective film is preferably as thin as possible from the standpoint of meeting the requirement for thinner films, and it is preferably 90 μm or less and more preferably 50 μm or less in thickness. On the other hand, if too thin, its strength lowers resulting in poor workability, thus, the thickness is preferably 5 μm or more.

### (Other Optical Layer)

The above-described polarizing plate can be used as a polarizing plate laminated with another optical layer in actual use.

The above-described protective film may have the function of such an optical layer.

Examples of said another optical layer include a reflection mode polarizing film which allows permeation of a certain polarized light and reflects a polarizing light showing the opposite characteristics thereto, an anti-glare-functional film having an uneven surface, a reflection-prevention film having a reflection-prevention function on the surface, a reflection film having a reflection function on the surface, a semi-permeable reflection film having a reflection function and a permeation function together, and a view angle compensation film.

Examples of commercially available products corresponding to the reflection mode polarizing film which allows permeation of a certain polarizing light and reflects a polarizing light showing the opposite characteristics include DBEF (manufactured by 3M, available from Sumitomo 3M Limited) and APF (manufactured by 3M, available from Sumitomo 3M Limited). The view angle compensation film includes an optical compensation film in which a liquid crystalline compound has been applied and oriented to the surface of a base material, a retardation film composed of a polycarbonate resin, and a retardation film composed of a cyclic polyolefin resin. Commercially available products corresponding to the optical compensation film in which a liquid crystalline compound is applied and oriented to the surface of a base material include WV film (manufactured by Fujifilm Corporation), NH film (manufactured by Nippon Oil Corporation), NR film (manufactured by Nippon Oil Corporation) and the like. Commercially available products corresponding to the retardation film composed of a cyclic polyolefin resin include ARTON (registered trademark) film (manufactured by JSR Corporation), Escena (registered trademark) (manufactured by Sekisul Chemical Co., Ltd.), ZEONOR (registered trademark) film (manufactured by Optes Co., Ltd.) and the like.

### <Process for Producing Polarizing Laminate Film>

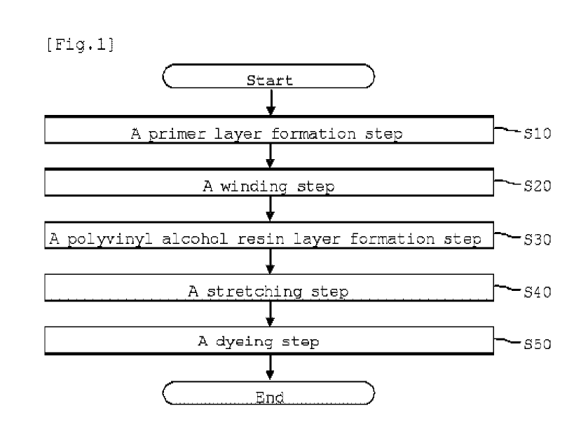

FIG. 1 is a flow chart showing one embodiment of a process for producing a polarizing laminate film. As shown in FIG. 1, the process for producing a polarizing laminate film of this embodiment comprises the following steps to be performed in order,

a primer layer formation step (S10) of forming a primer layer by applying a primer solution to one surface of a base film,

a winding step (S20) of temporarily winding the base film on which the primer layer is formed,

a polyvinyl alcohol resin layer formation step (S30) of forming a polyvinyl alcohol resin layer on the primer layer after again taking out the wound base film on which the primer layer has been formed, to obtain a laminate film comprising, in order, the base film, the primer layer and a polyvinyl alcohol resin layer,

a stretching step (S40) of stretching the laminate film, and

a dyeing step (S50) of dyeing the polyvinyl alcohol resin layer of the laminate film with a dichroic dye to obtain a polarizer layer.

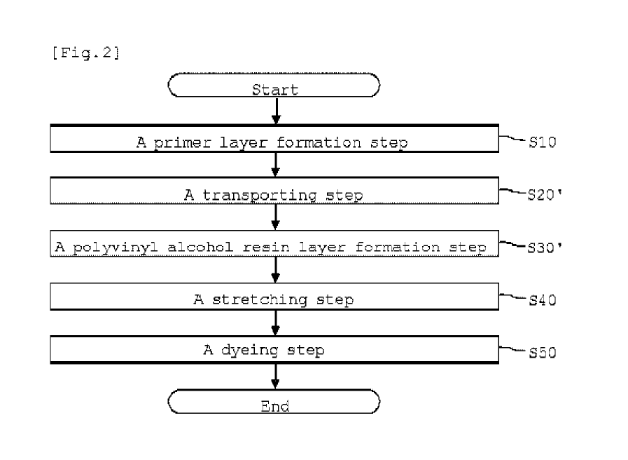

FIG. 2 is a flow chart showing another embodiment of the process for producing a polarizing laminate film. As shown in FIG. 2, the process for producing a polarizing laminate film of this embodiment comprises the following steps to be performed in order,

a primer layer formation step (S10) of forming a primer layer by applying a primer solution to one surface of a base film,

a transporting step (S20′) of transporting by a roll the base film on which the primer layer has been formed, to a place where a polyvinyl alcohol resin layer formation step is to be carried out,

a polyvinyl alcohol resin layer formation step (S30′) of forming a polyvinyl alcohol resin layer on the primer layer to obtain a laminate film comprising, in order, the base film, the primer layer and a polyvinyl alcohol resin layer,

a stretching step (S40) of stretching the laminate film, and

a dyeing step (S50) of dyeing the polyvinyl alcohol resin layer of the laminate film with a dichroic dye to obtain a polarizer layer.

The polarizing laminate film obtainable by these production processes is a polarizing laminate film having a polarizer layer 10 μm or less in thickness on a stretched base film. This can be used as it stands as a polarizing plate, or as described below, also as an intermediate article for transferring a polarizer layer to a protective film.

### <Process for Producing Polarizing Plate>

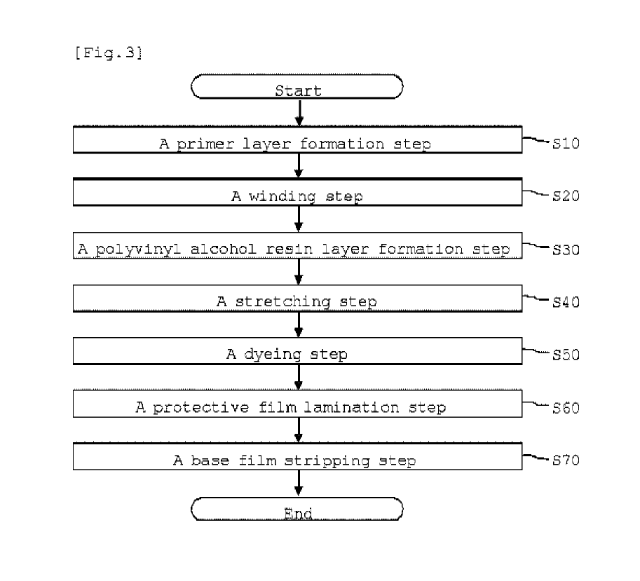

FIG. 3 is a flow chart showing one embodiment of a process for producing a polarizing plate. As shown in FIG. 3, the process for producing a polarizing plate of this embodiment comprises, in order,

the same steps (S10 to S50) as those in the above-described process for producing a polarizing laminate film shown in FIG. 1,

a protective film lamination step (S60) of laminating a protective film on the surface of a polarizing laminate film opposite from the base film, and

a base film stripping step (S70) of stripping away the base film from the polarizing laminate film.

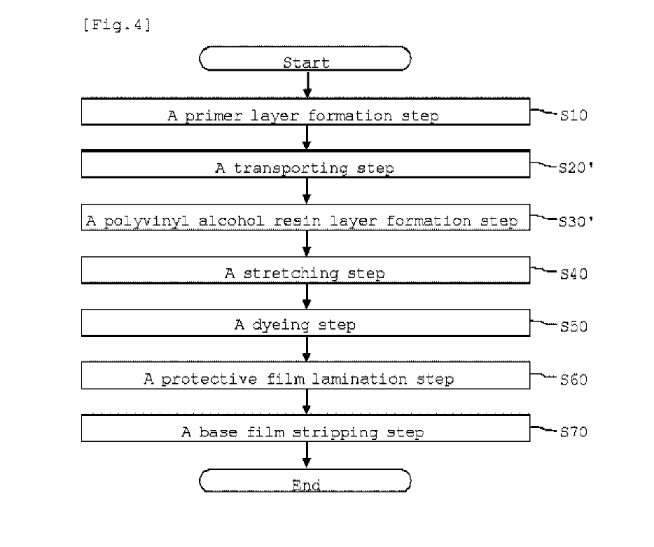

FIG. 4 is a flow chart showing another embodiment of the process for producing a polarizing plate. As shown in FIG. 4, the process for producing a polarizing plate of this embodiment comprises, in order,

the same steps (S10 to S50) as those in the above-described process for producing a polarizing laminate film shown in FIG. 2,

a protective film lamination step (S60) of laminating a protective film on the surface of a polarizing laminate film opposite from the base film, and

a base film-stripping step (S70) of stripping away the base film from the polarizing laminate film.

The polarizing plate obtainable by these production processes is a polarizing plate having a polarizer layer 10 μm or less in thickness on a protective film. This polarizing plate may be used in such a manner as that laminated to other optical film or other liquid crystal cell via a pressure-sensitive adhesive.

### <Production Steps>

Steps S10 to S70, S20′ and S30′ in FIGS. 1 to 4 will be illustrated in detail below. The steps S10 to S50 are the same in FIG. 1 and FIG. 3, and the steps S10 to S50 are the same in FIG. 2 and FIG. 4.

### (Primer Layer Formation Step (S10))

Here, a primer layer is formed on one surface of a base film.

The material suitable for the base film is as described above in the explanation of the constitution of a polarizing laminate film. In this embodiment, it is preferable to use a base film which can be stretched in the temperature range suitable for stretching of a polyvinyl alcohol resin.

The thickness of the primer layer formed on the base film (before stretching step) is preferably 0.05 to 1 μm and further preferably 0.1 to 0.4 μm. When thinner than 0.05 μm, there is a general tendency of lowering of adhesion force between the base film and the polyvinyl alcohol layer, while when thicker than 1 μm, a polarizing plate becomes thicker.

Preferably, a polyvinyl alcohol resin solution obtained by dissolving a powder of a polyvinyl alcohol resin in a solvent is prepared as a primer solution, then, applied to one surface of a base film, and dried by vaporizing the solvent, to form a primer layer.

If necessary, the primer solution may be blended with a cross-linker. In the case of use of an epoxy type cross-linker as the cross-linker, it is necessary that the solid component content will be less than 0.1 wt %. Solid component content of 0.1 wt % or more is undesirable since blocking occurs in winding a primer layer after formation thereof.

The solvent of the primer solution is preferably a solvent showing low solvency for a base film and more preferably water.

For enhancing adhesion between a base film and a primer layer, an adhesion-improving treatment such as a corona treatment, a plasma treatment, a flame treatment and the like may be carried out on the base film.

The method of applying a primer solution to a base film can be appropriately selected from among known methods such as a wire bar coating method, roll coating methods such as reverse coating, gravure coating and the like; a die coat method, a comma coat method, a lip coat method, a spin coating method, a screen coating method, a fountain coating method, a dipping method, a spray method and the like.

The drying temperature is preferably 50 to 200° C. and more preferably 60 to 150° C. The drying time is preferably 1 to 30 minutes and more preferably 2 to 20 minutes. In particular, when the solvent of a primer solution is water, the drying temperature is preferably 50 to 200° C. and the drying time is preferably 1 to 60 minutes.

After the formation of a primer layer, the base film on which the primer layer has been formed is temporarily wound. However, for example, it is possible to perform application continuously without winding in the case of an apparatus having two or more applicators on a line.

After the formation of a primer layer, the base film receives driving force by a roll such as for example nip rolls, suction rolls and the like and transported to the subsequent step without being wound. While the application surface comes into contact with the roll surface when a film is sandwiched by nip rolls, the use of nip rolls is preferable since a film slides rarely and large driving force can be imparted. The material of the nip roll includes rubbers, stainless steel and the like, and a rubber roll is preferable to reduce damage to the film. A film route to the subsequent step is formed by guide rolls. Though varying according to the space of the apparatus, it is preferable that guide rolls are mutually placed at a short distance so as to keep tension to prevent relaxation of a film and the film route is zigzag. For the guide roll, a stainless steel polishing roll is preferably used because of excellent smoothness.

The transportation roll may have functions such as heating, cooling and the like. The film transportation method is not particularly restricted, and may be carried out by general tension control, or the end of a film may be clipped by a clip and transported.

### (PVA Resin Layer Formation Step (S30))

Here, the temporarily wound base film on which a primer layer has been formed is taken out again, and a resin layer composed of a polyvinyl alcohol resin is to be formed on the surface of a primer layer. By this, a laminate film in which the polyvinyl alcohol resin layer is laminated via the primer layer on the base film, is obtained.

### (PVA Resin Layer Formation Step (S30′))

Here, a resin layer composed of a polyvinyl alcohol resin is formed on the surface of a primer layer. By this, a laminate film in which the polyvinyl alcohol resin layer is laminated via the primer layer on the base film, is obtained.

The thickness of the polyvinyl alcohol resin layer to be formed (before stretching) is preferably larger than 3 μm and not larger than 30 μm and further preferably 5 to 20 μm. In general, when 3 μm or less, there is a tendency that the layer becomes too thin after stretching leading to deterioration of a dyeing property, while when over 30 μm, the thickness of the finally obtained polarizer layer is over 10 μm in some cases.

Preferably, a polyvinyl alcohol resin solution obtained by dissolving a powder of a polyvinyl alcohol resin in a good solvent is applied to one surface of a base film, and dried by vaporizing the solvent, to form a polyvinyl alcohol resin layer. By thus forming the polyvinyl alcohol resin layer, it is possible to make the polyvinyl alcohol resin layer thinner. The method of applying the polyvinyl alcohol resin solution to a base film can be appropriately selected from known methods such as a wire bar coating method, roll coating methods such as reverse coating, gravure coating and the like; a die coat method, a comma coat method, a lip coat method, a spin coating method, a screen coating method, a fountain coating method, a dipping method, a spray method and the like. The drying temperature is for example 50 to 200° C. and preferably 60 to 150° C. The drying time is for example 2 to 20 minutes.

### (Stretching Step (S40))

Here, a laminate film composed of a base film and a polyvinyl alcohol resin layer is dry-stretched. Preferably, uniaxial stretching is performed so as to give a stretch ratio of 5 or more and 17 or less. Further preferably, uniaxial stretching is performed so as to give a stretch ratio of 5 or more and 8 or less. When the stretch ratio is 5 or less, a polyvinyl alcohol resin layer is not sufficiently oriented in general, and accordingly, the degree of polarization of a polarizer layer is not high enough in some cases. In contrast, when the stretch ratio is over 17, a laminate film in stretching tends to be broken in general, and simultaneously, the thickness of the laminate film after stretching becomes too thinner than required, leading to concerns of lowering of workability and handling in the subsequent step. The stretching treatment in the stretching step (S40) is not limited to single stage stretching and can be carried out also by multi-stage stretching. In the case of multi-stage, the stretching treatment is carried out so that a stretch ratio summed up for all stages of the stretching treatment exceeds 5.

In the stretching step (S40) in this embodiment, a longitudinal stretching treatment carried out along the longitudinal direction of a laminate film, a lateral stretching treatment stretching along the lateral direction, and the like can be performed.

The longitudinal stretching method includes an inter-roll stretching method, a compression stretching method and the like, and the lateral stretching method includes a tenter method and the like.

While the stretching treatment, any of a wet stretching treatment and a dry stretching treatment can be adopted, it is preferable to use a dry stretching treatment since the temperature in stretching a laminate film can be selected in a wider range.

### (Dyeing Step (S50))

Here, a polyvinyl alcohol resin layer of a stretched film is dyed with a dichroic dye.

Examples of the dichroic dye include iodine, organic dyes and the like. The organic dyes which can be used are, for example, Red BR, Red LR, Red R, Pink LB, Rubin BL, Bordeaux GS, Sky Blue LG, Lemon Yellow, Blue BR, Blue 2R, Navy RY, Green LG, Violet LB, Violet B, Black H, Black B, Black GSP, Yellow 3G, Yellow R, Orange LR, Orange 3R, Scarlet GL, Scarlet KGL, Congo Red, Brilliant Violet BK, Supra Blue G, Supra Blue GL, Supra Orange GL, Direct Sky Blue, Direct Fast Orange S, Fast Black and the like. These dichroic materials may be used singly or in combination.

The dyeing step is carried out, for example, by immersing the whole stretched film in a solution containing the above-described dichroic dye (dyeing solution). As the dyeing solution, a solution prepared by dissolving the above-described dichroic dye in a solvent can be used. As the solvent of the dyeing solution, water is generally used, however, an organic solvent having compatibility with water may further be added. The content of the dichroic dye is preferably 0.01 to 10 wt %, more preferably 0.02 to 7 wt % and particularly preferably 0.025 to 5 wt %.

In the case of use of iodine as the dichroic dye, further addition of an iodide is preferable since dyeing efficiency can be further improved. Examples of the iodide include potassium iodide, lithium iodide, sodium iodide, zinc iodide, aluminum iodide, lead iodide, copper iodide, barium iodide, calcium iodide, tin iodide, titanium iodide and the like. The addition proportion of these iodides is preferably 0.01 to 20 wt % in the dyeing solution. Among iodides, potassium iodide is preferably added. In the case of addition of potassium iodide, the weight ratio of iodine to potassium iodide is preferably in the range of 1:5 to 1:100, more preferably in the range of 1:6 to 1:00 and particularly preferably in the range of 1:7 to 1:70.

The immersion time of a stretched film in the dyeing solution is not particularly restricted, and usually, it is preferably in the range of 15 seconds to 15 minutes and more preferably in the range of 1 to 3 minutes. The temperature of the dyeing solution is preferably in the range of 10 to 60° C. and more preferably in the range of 20 to 40° C.

In the dyeing step, a cross-linking treatment can be carried out subsequent to dyeing. The cross-linking treatment can be carried out, for example, by immersing a stretched film in a solution containing a cross-linker (cross-linking solution). As the cross-linker, conventionally known substances can be used. Examples thereof include boron compounds such as boric acid, borax and the like, glyoxal, glutaraldehyde and the like. These may be used singly or in combination.

As the cross-linking solution, a solution prepared by dissolving a cross-linker in a solvent can be used. As the solvent, water can be used for example, and further, an organic solvent having compatibility with water may also be contained. The content of a cross-linker in the cross-linking solution is preferably in the range of 1 to 20 wt % and more preferably in the range of 6 to 15 wt %, but not limited to this.

In the cross-linking solution, an iodide may be added. By addition of an iodide, the polarization property within the plane of a polyvinyl alcohol resin layer can be more uniform. Examples of the iodide include potassium iodide, lithium iodide, sodium iodide, zinc iodide, aluminum iodide, lead iodide, copper iodide, barium iodide, calcium iodide, tin iodide and titanium iodide. The content of the iodide is 0.05 to 15 wt % and more preferably 0.5 to 8 wt %.

As the immersion time of a stretched film in the cross-linking solution, usually, it is preferably 15 seconds to 20 minutes and more preferably 30 seconds to 15 minutes. The temperature of the cross-linking solution is preferably in the range of 10 to 80° C.

By the above-described dyeing step (S50), a polyvinyl alcohol resin layer is imparted a function as a polarizer layer. In the present specification, the polyvinyl alcohol resin layer having a function as a polarizer is called a polarizer layer, and the laminate having a polarizer layer on a base film is called a polarizing laminate film.

Finally, carrying out a washing step and a drying step is preferable. As the washing step, a water-washing treatment can be performed. The water-washing treatment can be carried out, usually, by immersing a stretched film in pure water such as ion exchanged water, distilled water and the like. The water-washing temperature is usually in the range of 3 to 50° C. and preferably in the range of 4° C. to 20° C. The immersion time is usually 2 to 300 seconds and preferably 3 to 240 seconds.

In the washing step, a water-washing treatment may be combined with a washing treatment with an iodide solution, and a solution blended with a liquid alcohol such as methanol, ethanol, isopropyl alcohol, butanol, propanol and the like may also be used appropriately.

It is preferable to perform the drying step after the washing step. As the drying step, any suitable method (for example, natural drying, blow drying, heat drying) can be adopted. For example, the drying temperature in the case of heat drying is usually 20 to 95° C. and the drying time is usually about 1 to 15 minutes. After the washing step, a drainage step using nip rolls, an air knife and the like may be provided.

### (Protective Film Lamination Step (S60))

Herein, a protective film is laminated on the polarizer layer of the polarizing laminate film obtained via the above-described steps, opposite from the base film. As the method of laminating the protective film on the polarizer layer, there is a method of laminating the protective film on the polarizer layer via a pressure-sensitive adhesive layer or an adhesive layer. The material suitable as the protective film is as described above in the explanation of the constitution of the polarizing plate.

### (Pressure-Sensitive Adhesive Layer)

The pressure-sensitive adhesive constituting the pressure-sensitive adhesive layer is usually composed of a composition prepared by adding a cross-linker such as an isocyanate compound, an epoxy compound, an aziridine compound and the like to a base polymer such as an acrylic resin, a styrene resin, a silicone resin and the like. Further, fine particles can also be blended in the pressure-sensitive adhesive to form a pressure-sensitive adhesive layer showing a light scattering property.

The thickness of the pressure-sensitive adhesive layer is preferably 1 to 40 μm, and a smaller thickness is preferable on the premises of not deteriorating workability and durability, and more preferably 3 to 25 μm. The thickness in the range of 3 to 25 μm is a suitable thickness for providing excellent workability and restraining a change in dimension of a polarizing film. In general, when the thickness of the pressure-sensitive adhesive layer is less than 1 μm, pressure-sensitive adhesiveness tends to lower, and when over 40 μm, troubles such as protrusion of the pressure-sensitive adhesive and the like tend to occur.

The method of forming the pressure-sensitive adhesive layer on a protective film and a polarizer is not particularly restricted, and it may be permissible that a solution containing various components typically including the above-described base polymer is applied to the surface of a protective film or the surface of a polarizer layer, dried to form a pressure-sensitive adhesive layer, then, laminated to a separator or other film, or that a pressure-sensitive adhesive layer is formed on a separator, then, laminated to the surface of a protective film or the surface of a polarizer layer. Further, in forming a pressure-sensitive adhesive layer on the surface of a protective film or a polarizer layer, adhesion treatments, for example, a corona treatment and the like may be performed on the surface of a protective film or a polarized layer or on one surface of both surfaces of the pressure-sensitive adhesive layer, if necessary.

### (Adhesive Layer)

As the adhesive constituting the adhesive layer, for example, there are aqueous adhesives using polyvinyl alcohol resin aqueous solutions, aqueous two-liquid type urethane emulsion adhesives and the like. Out of these, polyvinyl alcohol resin aqueous solutions are suitably used. The polyvinyl alcohol resin used as the adhesive includes vinyl alcohol homopolymers obtained by saponifying polyvinyl acetate which is a homopolymer of vinyl acetate, and additionally, vinyl alcohol copolymers obtained by saponifying a copolymer composed of vinyl acetate and other monomer copolymerizable therewith, further, modified polyvinyl alcohol polymers obtained by partially modifying hydroxyl groups in the above-described polymers, and the like. In the aqueous adhesive, poly-valent aldehydes, water-soluble epoxy compounds, melamine compounds, zirconia compounds, zinc compounds and the like may be added as additives. In the case of use of such aqueous adhesives, the adhesive layer obtained therefrom is usually thinner by far than 1 μm, and even if the cross-section thereof is observed by a normal optical microscope, the adhesive layer is not virtually observed.

The method of laminating a film using the aqueous adhesive is not particularly restricted, and there is such a method in that an adhesive is applied uniformly to the surface of a film or poured thereon, another film is overlapped on the applied surface and laminated by rolls and the like, and dried. Usually, after preparation thereof, the adhesive is applied at a temperature of 15 to 40° C. and the lamination temperature is usually in the range of 15 to 30° C.

In the case of use of the aqueous adhesive, after a film has been laminated, the laminate is dried to remove water contained in the aqueous adhesive. The temperature of a drying furnace is preferably 30° C. to 90° C. When lower than 30° C., the adhered surface tends to be stripped. When higher than 90° C., the optical performance of a polarizer and the like is deteriorated by heat in some cases. The drying time can be 10 to 1000 seconds.

After drying, the laminate may be further cured at room temperature or somewhat higher temperatures, for example, about 20 to 45° C. for about 12 to 600 hours. The temperature in curing is normally set lower than the temperature in drying.

As non-aqueous adhesives, photo-curable adhesives can also be used. Examples of the photo-curable adhesive include mixtures of photo-curable epoxy resins and light cation polymerization initiators.

For laminating a film with the photo-curable adhesive, conventionally known methods can be used, and there is such a method in that an adhesive is applied by a cast method, a meyer bar coat method, a gravure coat method, a comma coater method, a doctor blade method, a die coat method, a dip coat method, a spray method and the like to the film surface to be adhered, and two films are overlapped. In the casting method, two films to be applied are moved toward approximately vertical direction, approximately horizontal direction, or oblique direction between these, and an adhesive is allowed to flow and spread on the surface thereof.

After application of an adhesive to the surface of films, the films are sandwiched by nip rolls and the like and laminated and adhered. A method of pressing this laminate by rolls and the like to spread the adhesive uniformly can also be suitably used. In this case, for the material of the roll, metals, rubbers and the like can be used. Further, a method in which this laminate is passed through between a roll and a roll and pressed to spread the adhesive is also preferably adopted. In this case, these rolls may be made of the same material or different materials. The thickness before drying or curing of the adhesive layer after lamination using the above-described nip rolls and the like is preferably 5 μm or less and 0.01 μm or more.

On the film surface to be adhered, surface treatments such as a plasma treatment, a corona treatment, an ultraviolet irradiation treatment, a flame treatment, a saponification treatment and the like may be appropriately performed for improving adhesiveness. The saponification treatment comprise methods of immersing into an aqueous solution of an alkali such as sodium hydroxide and potassium hydroxide.

In the case of use of the photo-curable resin for the adhesive, the photo-curable adhesive is cured by irradiation with an active energy ray after laminating films. The source of the active energy ray is not particularly restricted, and active energy rays having distribution of light emission at wavelengths not higher than 400 nm are preferable, and specifically, a low pressure mercury lamp, a middle pressure mercury lamp, a high pressure mercury lamp, an ultrahigh pressure mercury lamp, a chemical lamp, a black light lamp, a microwave excitation mercury lamp, a metal halide lamp and the like are preferably used.

The irradiation intensity on the photo-curable adhesive is appropriately determined according to the composition of the photo-curable adhesive and is not particularly restricted, and the irradiation intensity in a long wavelength region effective for activation of a polymerization initiator is preferably 0.1 to 6000 mW/cm². In general, when the irradiation intensity is 0.1 mW/cm² or more, the reaction time is not too long, and when 6000 mW/cm² or less, there is little possibility of occurrence of yellowing of an epoxy resin and deterioration of a polarizing film due to heat radiated from a light source and generated in curing of the photo-curing adhesive. The applied irradiation time on the photo-curable adhesive depends on the photo-curable adhesive to be cured and is not particularly restricted, and the cumulative light quantity represented by the product of the above-described irradiation intensity and the irradiation time is preferably set to 10 to 10000 mJ/cm². When the cumulative light quantity on the photo-curable adhesive is 10 mJ/cm² or more, active species derived from a polymerization initiator can be generated in sufficient amount to progress the curing reaction more steadily, and when 10000 mJ/cm² or less, the irradiation time is not too long and excellent productivity can be maintained. The thickness of the adhesive layer after irradiation with an active energy ray is usually about 0.001 to 5 μm, preferably 0.01 μm or more and 2 μm or less and further preferably 0.01 μm or more and 1 μm or less.

In the case of curing a photo-curable adhesive of a film containing a polarizer layer and a protective film by irradiation of an active energy ray, it is preferable to carry out curing under conditions causing no lowering of various functions of a polarizing plate, such as the degree of polarization, transmittance and hue of a polarizer layer and the transparency of a protective film.

### (Base Film-Stripping Step (S70))

After the protective film lamination step (S60), a base film stripping step (S70) of stripping a base film from a polarizing laminate film is carried out. The stripping method of a base film is not particularly restricted, and the same method as the film stripping step carried out on a usual polarizing plate with an adhesive can be adopted. After the protective film lamination step (S60), stripping may be performed immediately as it stands, or after temporarily wound in the form of roll, a stripping step may be separately provided.

### EXAMPLES

### Example 1

A polarizing plate was produced according to a producing process shown in FIG. 2.

### (Primer Layer Formation Step)

For the base film, a non-stretched polypropylene (PP) 100 μm in thickness was used.

A polyvinyl alcohol powder (manufactured by The Nippon Synthetic Chemical Industry Co., Ltd., degree of saponification: 99.5 mol %, trade name: Z-200) was dissolved in hot water of 95° C., to prepare an aqueous solution in which the weight ratio of water:polyvinyl alcohol powder was 100:3, as the no-cross-linker-containing primer solution. The resultant primer solution was applied to a base film having been subjected to a corona treatment, dried at 80° C. for 10 minutes, to form a primer layer having a thickness of 0.3 μm.

The base film on which this primer layer has been formed was subjected to the following experiment and the extent of blocking thereof was checked.

### <Blocking Experiment>

(1) A film is prepared to which a primer layer having a size of 300 mm×220 mm or more was applied.

(2) The primer-applied film is overlapped so that the primer-applied surface and the base film (PP) surface come into contact.

(3) The overlapped films are sandwiched between glass plates of 300 mm×220 mm and a load of 2 kg is placed thereon and are brought into an over of 40° C.

(4) The films are taken out after 9 days, the films are stripped and the proportion of the area of blocking in 100 mm×100 mm is evaluated and expressed by percentage.

The results are shown in Table 1. During stripping, particular resistance was not detected.

### (PVA Resin Layer Formation Step)

A polyvinyl alcohol powder (manufactured by Kuraray Co., Ltd., average degree of polymerization 2400, degree of saponification 98.0 to 99.0 mol %, trade name: PVA124) was dissolved in hot water of 95° C. to prepare an aqueous solution of a polyvinyl alcohol having a content of 8 wt %. The resultant aqueous solution was applied to the above-described primer layer using a bar coater and dried at 80° C. for 20 minutes, to produce a three-layered laminate film composed of a base film, a primer layer and a polyvinyl alcoholic resin layer. The thickness of the polyvinyl alcoholic resin layer (resin layer composed of polyvinyl alcohol) was 15 μm.

A part of the resultant laminate film was subjected to the following experiment to confirm its stretchability, separately from the stretching step described later.

### <Experiment to Confirm Stretchability>

(1) The resultant laminate film is cut into 100 mm in width direction×40 mm in length direction.

(2) The out sample is stretched (initial inter-chuck distance: 30 mm) with Autograph (manufactured by SHIMADZU Corporation, AG-1) at 150° C. under a test rate of 300 mm/min, and the stretch ratio at which stripping of the polyvinyl alcohol layer initiates is checked.

The results are shown in Table 1.

(Stretching step)

The laminate film obtained in the above-described PVA resin layer formation step was stretched 5.8 times along the longitudinal uniaxial direction by a tenter stretching machine. In this operation, stripping of the polyvinyl alcohol layer was not observed.

### (Dyeing Step)

The stretched laminate film was immersed in a hot bath of 60° C. for 60 seconds, and then, immersed in a dyeing solution which was an aqueous solution composed of iodine and potassium iodide (0.3 parts by weight of iodine and 5 parts by weight of potassium iodide with respect to 100 parts by weight water) of 30° C. for 300 seconds. Then, excess iodine liquid was washed away with pure water of 10° C. Next, the film was immersed in a cross-linking solution which was an aqueous solution composed of boric acid and potassium iodide (8 parts by weight of boric acid and 5 parts by weight of potassium iodide with respect to 100 parts by weight water) of 76° C. for 300 seconds. Thereafter, the film was washed with pure water of 10° C. for 4 seconds, dried at 50° C. for 300 seconds, to obtain a polarizing laminate film. The thickness of the polyvinyl alcohol resin layer (polarizer layer) in the polarizing laminate film after stretching and dyeing was 7.4 μm.

### (Protective Film Lamination Step)

On polarizer side of the above-described polarizing laminate film, a protective film (TAC manufactured by Konica Minolta Opto Products Co., Ltd.: KC4UY, thickness: 40 μm) was laminated by use of a polyvinyl alcohol adhesive, and dried at 80° C. for 5 minutes, to obtain a polarizing laminate film equipped with the protective film, which has the base film and the protective film.

A polyvinyl alcohol powder (manufactured by Kuraray Co., Ltd., average degree of polymerization: 1800, trade name: KL-318) was dissolved in hot water of 95° C. to prepare an aqueous solution having a content of 3 wt %, and the resultant aqueous solution was mixed with a cross-linker solution (manufactured by Sumika Chemtex Co., Ltd., trade name: Sumirez (registered trademark) resin 650) in an amount of 1 part by weight with respect to 2 parts by weight of the polyvinyl alcohol powder, to give an adhesive solution, which was used as the above-described polyvinyl alcohol adhesive.

### (Base Film Stripping Step)

The base film was stripped manually. The base film was stripped easily, to obtain a four-layer polarizing plate composed of the protective film, the adhesive layer, the polarizer layer and the primer layer. The thickness of the polarizer layer in the resultant polarizing plate was 7.4 μm, like the polarizer layer in the above-described polarizing laminate film.

In the above-described steps, problems such as stripping of the polyvinyl alcohol layer and the like did not occur, and a polarizing plate could be produced with high productivity.

### Example 2

For the base film, a non-stretched polypropylene film 100 μm in thickness was used, as in Example 1.

A polyvinyl alcohol powder (manufactured by The Nippon Synthetic Chemical Industry Co., Ltd., degree of saponification 99.5 mol %, trade name: Z-200) was dissolved in hot water of 95° C., to prepare an aqueous solution in which the weight ratio of water:polyvinyl alcohol powder was 100:3, further, an epoxy type cross-linker solution (manufactured by Sumika Chemtex Co., Ltd., trade name: Sumirez (registered trademark) resin 650, aqueous solution having solid component content of 30 wt %) was added and mixed so that the amount of epoxy type cross-linker (solid component) was 0.09 parts by weight with respect to 6 parts by weight of the polyvinyl alcohol powder, to prepare a primer solution. At this time, the content of the epoxy type cross-linker (solid component) in the primer solution was 0.04 wt %.

The resultant primer solution was applied to a base film having been subjected to a corona treatment, and dried at 80° C. for 10 minutes, to form a primer layer having a thickness of 0.2 μm.

### (Blocking Experiment, Experiment to Confirm Stretchability)

The base film on which this primer layer was formed was subjected to a blocking experiment in the same manner as in Example 1. The laminate film on which the polyvinyl alcohol layer was formed was subjected to an experiment to confirm stretchability in the same manner as in Example 1. The results are shown in Table 1.

### Comparative Example 1

### Primer Layer Formation Step

For the base film, a non-stretched polypropylene film 100 μm in thickness was used, as in Example 1.

A polyvinyl alcohol powder (manufactured by The Nippon Synthetic Chemical Industry Co., Ltd., degree of saponification 99.5 mol %, trade name: Z-200) was dissolved in hot water of 95° C., to prepare an aqueous solution in which the weight ratio of water:polyvinyl alcohol powder was 100:3, further, an epoxy type cross-linker solution (manufactured by Sumika Chemtex Co., Ltd., trade name: Sumirez (registered trademark) resin 650, aqueous solution having solid component content of 30 wt %) was mixed so that the amount of the epoxy type cross-linker (solid component) was 2.1 parts by weight with respect to 6 parts by weight of the polyvinyl alcohol powder, to prepare a primer solution. At this time, the content of the epoxy type cross-linker in the primer solution was 0.98 wt %.

The resultant primer solution was applied to a base film having been subjected to a corona treatment, and dried at 80° C. for 10 minutes, to form a primer layer having a thickness of 0.2 μm.

(Blocking Experiment, Experiment to Confirm stretchability)

The base film on which this primer layer was formed was subjected to a blocking experiment in the same manner as in Example 1. The laminate film on which the polyvinyl alcohol layer was formed was subjected to an experiment to confirm stretchability in the same manner as in Example 1. The results are shown in Table 1.

### Comparative Example 2

A primer layer having a thickness of 0.3 μm was formed in the same manner as in Comparative Example 1 excepting that the compounding amount of the epoxy type cross-linker in the primer solution was 1 part by weight with respect to 6 parts by weight of the polyvinyl alcohol powder. At this time, the content of the epoxy type cross-linker in the primer solution was 0.14 wt %.

### (Blocking Experiment, Experiment to Confirm Stretchability)

The base film on which this primer layer was formed was subjected to a blocking experiment in the same manner as in Example 1. The laminate film on which the polyvinyl alcohol layer was formed was subjected to an experiment to confirm stretchability in the same manner as in Example 1. The results are shown in Table 1.

The thickness of the polarizer layer described in Table 1 shows the thickness of the polarizer layer (polyvinyl alcoholic resin layer) in the polarizing laminate film, for Example 1. For each of Example 2, Comparative Example 1 and Comparative Example 2, the each thickness described in Table 1 shows the thickness of the polarizer layer (polyvinyl alcoholic resin layer) in the polarizing laminate film fabricated by subjecting the same laminate film as having been subjected to each experiment to confirm stretchability, to the same stretching step (stretch ratio: 5.8 times) and the dyeing step as in Example 1.

TABLE 1

| | Content of | | | |
|---|---|---|---|---|
| | epoxy type | | Stretch ratio | |
| | cross-linker | proportion | at which PVA | Thickness |
| | in primer | of the | resin layer | of polarizer |
| | solution | area of | is stripped | layer |
| | (w/w %) | blocking (%) | (times) | (μm) |
| Example 1 | 0 | 0 | 6.1 | 7.4 |
| Example 2 | 0.04 | 0 | 6.1 | 7.2 |
| Comparative | 0.98 | 60 | 6.3 | 7.0 |
| Example 1 | | | | |
| Comparative | 0.14 | 5 | 6.3 | 7.3 |
| Example 2 | | | | |

As shown in Table 1, it is understood that in Examples 1 and 2 of the present invention, blocking did not occur, while in Comparative Examples 1 and 2, blocking occurred.

In Examples 1 and 2, slight stripping occurred in the polyvinyl alcohol layer at a stretch ratio of 6.1 times. This result is approximately the same as 6.3 times in Comparative Examples 1 and 2, teaching that the laminate films of Examples 1 and 2 have the same adhesion as the laminate films of Comparative Examples 1 and 2 using the primer solution containing the epoxy type cross-linker in an amount of 0.1 wt % or more.

### Example 3

In this example, an organometal compound (titanium complex “Orgatics-TC310 (trade name)” (manufactured by Matsumoto Pharmaceutical Manufacture Co., Ltd., solution composed of active ingredient (chemical structure: (HO)₂Ti[OCH(CH₃)COOH]₂) 44 wt %, isopropyl alcohol 40 wt % and water 16 wt %) was used as the cross-linker for the primer solution.

First, water, isopropyl alcohol and “Orgatics TC-310” were mixed so that the weight ratio of water:isopropyl alcohol:TC-310 was 85:15:7.5, to prepare a solution A. Here, the weight ratio of TC-310 means the weight of the whole solution containing the organometal compound.

Separately, a polyvinyl alcohol powder (manufactured by Kuraray Co., Ltd., degree of saponification: about 80 mol %, trade name: KL506) was dissolved in an amount of 15 parts by weight with respect to 100 parts by weight water of 80° C., to prepare a polyvinyl alcohol aqueous solution (solution B).

The solution A and the solution B were mixed so that the weight ratio of solution A:solution B was 1.3:4, to prepare a primer solution. At this time, the content of the solid component of Organotics TC-300 in the primer solution was 0.75 wt %.

A primer layer having a thickness of 0.2 μm was formed on a base film, in the same manner as in Example 1.

A four-layer polarizing plate composed of a protective film, an adhesive layer, a polarizer layer and a primer layer was obtained by performing from the PVA resin layer formation step to the base film stripping step in the same manner as in Example 1. The thickness of the polarizer layer in the resultant polarizing plate was 7.6 μm.

### Example 4

In this example, a water-dispersible polyisocyanate cross-linker (manufactured by DIC Corporation, trade name: Barnoc DWN-5000, diethylene glycol dimethyl ether solution having solid component content of about 80 wt %) was used as the cross-linker.

First, water was mixed with a polyvinyl alcohol powder (manufactured by Kuraray Co., Ltd., degree of saponification: about 80 mol %, trade name: PVA-403) while heating at 80° C., and stirred, then, cooled down to room temperature, and further, the above-described water-dispersible polyisocyanate cross-linker was added and the mixture was stirred, to prepare a primer solution. The weight ratio of water:polyvinyl alcohol:cross-linker was adjusted to 100:15:5. Here, the weight of the polyisocyanate cross-linker means the weight of the whole solution containing the solvent. At this time, the content of the solid component of Barnoc DWN-5000 in the primer solution was 3.3 wt %.

A primer layer having a thickness of 0.2 μm was formed on a base film, in the same manner as in Example 1.

A four-layer polarizing plate composed of a protective film, an adhesive layer, a polarizer layer and a primer layer was obtained by performing from the PVA resin layer formation step to the base film stripping step in the same manner as in Example 1. The thickness of the polarizer layer in the resultant polarizing plate was 7.5 μm.

### Example 5

Completely saponified PVA (average degree of polymerization: about 1700, degree of saponification: 99.6 mol % or more) was dissolved in water of 95° C., to prepare a polyvinyl alcohol aqueous solution, the solution was cooled down to room temperature, then, a glyoxal aqueous solution (39 wt % aqueous solution) as a dialdehyde cross-linker was added and the mixture was stirred, to prepare a primer solution. The weight ratio of completely saponified PVA:water:glyoxal aqueous solution was adjusted to 5:100:0.6. At this time, the content of the solid component of glyoxal in the primer solution was 0.23 wt %.

A primer layer having a thickness of 0.2 μm was formed on a base film, in the same manner as in Example 1.

A four-layer polarizing plate composed of a protective film, an adhesive layer, a polarizer layer and a primer layer was obtained by performing from the PVA resin layer formation step to the base film stripping step in the same manner as in Example 1. The thickness of the polarizer layer in the resultant polarizing plate was 7.8 μm.

### (Blocking Experiment)

The same blocking experiment as in Example 1 was carried out for the base film on which the primer layer was formed in Examples 3 to 5. The results are shown in Table 2.

TABLE 2

| | | | Thickness of |
|---|---|---|---|
| | | proportion of the area | polarizer |
| | Cross-linker | of blocking (%) | layer (μm) |
| Example 3 | Organotics TC-300 | 0 | 7.6 |
| | (titanium complex) | | |
| Example 4 | Organotics ZB-400 | 0 | 7.2 |
| | (zirconium complex) | | |
| Example 5 | Glyoxal (dialdehyde | 0 | 7.8 |
| | cross-linker) | | |

From the results shown in Table 2, it is understood that blocking does not occur even if a cross-linker is contained in the primer solution, providing that the cross-linker is a compound other than epoxy type cross-linkers

### Example 6

Long base film of the same kind as in Example 1 was prepared and subjected to a corona treatment. The primer solution used in Example 1 was applied to the corona-treated surface and dried at 80° C. for 2 minutes, to form a primer layer having a thickness of 0.3 μm. After formation of the primer layer, temporarily wound to produce a roll. One day after roll production, blocking did not occur during taking out the film, and the subsequent PVA resin formation step was started without problems. The results are shown in Table 3.

### Example 7

A primer layer having a thickness of 0.3 μm was formed on a long base film in the same manner as in Example 6. After formation of the primer layer, the film was transported to the subsequent step without winding. The transportation was carried out with nip rolls and guide rolls. Though the surfaces of the nip rolls and guide rolls came into touch with the primer layer occasionally, the subsequent PVA resin layer formation step could be started without particular problems such as sticking. The results are shown in Table 3.

### Comparative Example 3

A primer layer having a thickness of 0.3 μm was formed on a long base film in the same manner as in Example 6 excepting that the primer solution used in Comparative Example 1 was used. After formation of the primer layer, the film was temporarily wound to produce a roll. One day after roll production, blocking occurred during taking out the film and the surface of the primer layer became roughened, resulting in remarkably poor quality. The results are shown in Table 3.

TABLE 3

| | Content of | | | |
|---|---|---|---|---|
| | epoxy type | | | |
| | cross- | | | |
| | linker in | After | | |
| | primer | primer | | |
| | solution | layer | | Transportation |
| | (W/W %) | formation | blocking | trouble |
| Example 6 | 0 | temporarily | none | — |
| | | wound | | |
| Example 7 | 0 | transported | — | none |
| | | to the sub- | | |
| | | sequent step | | |
| | | without | | |
| | | treatment | | |
| Comparative | 0.98 | temporarily | observed | — |
| Example 3 | | wound | | |

From the above-described results, it is understood that a primer layer which causes no blocking without deteriorating adhesion force with a polyvinyl alcohol layer, does not cause mutual pressure joining of films in a winding step, and does not stick to a transportation roll can be formed according to the present invention, as described above.

1. A process for producing a polarizing laminate film comprising a base film, a primer layer and a polarizer layer in order, which comprises the following steps, in order,
a primer layer formation step of forming a primer layer by applying a primer solution to one surface of a base film,
a polyvinyl alcohol resin layer formation step of forming a polyvinyl alcohol resin layer on the primer layer to obtain a laminate film comprising, in order, the base film, the primer layer and the polyvinyl alcohol resin layer,
a stretching step of stretching the laminate film, and
a dyeing step of dyeing the polyvinyl alcohol resin layer of the laminate film with a dichroic dye to obtain a polarizer layer,
wherein a content of an epoxy type cross-linker in the primer solution is less than 0.1% by weight.

2. The process according to claim 1, wherein the polyvinyl alcohol resin layer formation step is carried out after winding temporarily the base film on which the primer layer has been formed in the primer layer formation step and again taking out the base film.

3. The process according to claim 1, wherein the polyvinyl alcohol resin layer formation step is carried out after transporting by a roll the base film on which the primer layer has been formed in the primer layer formation step, to a place where the polyvinyl alcohol resin layer formation step is to be carried out.

4. The process according to claim 3, wherein the primer formation step, the transporting and the polyvinyl alcohol resin layer formation step are carried out successively in that order.

5. The process according to claim 1, wherein the base film comprises polyolefin resin.

6. The process according to claim 1, wherein the primer solution contains polyvinyl alcohol resin.

7. The process according to claim 1, wherein a solvent of the primer solution is the one having low solvency for the base film.

8. The process according to claim 1, wherein the stretch ratio in the stretching step is more than 5.

9. The process according to claim 1, wherein the thickness of the primer layer before the stretching step is from 0.05 to 1.0 μm.

10. The process according to claim 1, wherein the thickness of the polyvinyl alcohol resin layer before the stretching step is from 3 to 30 μm.

11. The process according to claim 1, wherein the thickness of the polarizer layer is 10 μm or less.

12. A process for producing a polarizing plate comprising a polarizer layer and a protective film formed on one surface of the polarizer layer, which comprises the following steps, in order,
a protective film lamination step of laminating a protective film on a surface of the polarizing laminate film opposite from the base film, wherein the polarizing laminate film is obtained by the process according to claim 1, and
a base film stripping step of stripping away the base film from the polarizing laminate film.
